(19) United States
(12) Patent Application Publication
(10) Pub. No.: US 2003/0138525 A1
(43) Pub. Date: Jul. 24, 2003

(54) Frozen sandwich and method of making same

(75) Inventors: Robert John Valenzky JR., Akron, OH (US); Duane Nathan Eberhart, Wooster, OH (US)

Correspondence Address: FAY, SHARPE, FAGAN, MINNICH & McKEE, Seventh Floor, 1100 Superior Avenue, Cleveland, OH, 44114-2579, US

(73) Assignee: The J.M. Smucker Company, an Ohio corporation

(21) Appl. No.: 10/356,840

(22) Filed: Feb. 3, 2003

Related U.S. Application Data
(62) Division of application No. 09/898,383, filed on Jul. 5, 2001.

(51) Int. Cl. A23G 3/00

(52) U.S. Cl. 426/94

(57) ABSTRACT

A frozen sandwich for commercial sales comprising a first portion of bread cut from a first slice of crusted bread. This first portion has an outer surface, a given periphery and a center area surrounded by a marginal area. A layer of unmelted solid cheese is deposited on the center area and is spaced inwardly from the marginal area. A second portion of bread cut from a second slice of crusted bread and overlying the first portion and the layer of cheese has an outer surface, a periphery generally matching the periphery of the first portion and a marginal area generally matching and coextensive with the marginal area of the first portion. The marginal areas are smashed together sufficiently to form a seal generally matching the peripheries of the bread portions. The surfaces of the bread portions are heat scorched to transform a thin skin of the portions into toasted bread.

The present invention relates to the art of prepared sandwiches for commercial sale in institutional and retail establishments and more particularly to a novel frozen sandwich and method of making the frozen sandwich.

### INCORPORATION BY REFERENCE

The frozen sandwich constituting the present invention is a crustless sandwich produced by a method disclosed in Kretchman U.S. Pat. No. 6,004,596. Consequently, this patent is incorporated by reference herein to describe the crustless sandwich technology and the general method of making such sandwich as background information to the present invention.

### BACKGROUND OF INVENTION

The crustless peanut butter sandwich manufactured by the procedure set forth in Kretchman U.S. Pat. No. 6,004,596 have been commercially distributed and marketed in the United States with immediate commercial success. Efforts have been made to adapt this technology to a crustless sandwich filled with cheese; however, this effort has not become commercially successful due to the technical difficulty in converting from peanut butter and jelly to cheese as the filler. Prior attempts to make this change have involved placing a slice of processed cheese between two slices of bread, which slices are ultimately cut into the desired shape and then sealed and crimped by pressure around the cheese. This sandwich used the technology in the prior patent and merely substituted the slice of cheese in the center of the crustless sandwich for the peanut butter and jelly filling. This frozen cheese sandwich construction produced a sandwich to be thawed by the user and toasted in a convection oven. In some instances, the frozen cheese sandwich was merely thawed and eaten as the peanut butter and jelly counterpart. Since a cheese slice was used, the sandwich must be rectangular and the properties of the cheese are dictated by the sliced cheese used in the sandwich. The heating process in a toaster tends to melt the cheese and change the structure of the resulting toasted sandwich. The sandwich did not duplicate a domestic grilled cheese sandwich. To melt the cheese, the bread was toasted to a deep level. These disadvantages and unacceptable resulting sandwich contribute to the marketing problems of converting the peanut butter and jelly sandwich to a cheese sandwich. Consumers would prefer to make a grilled cheese sandwich over the toasted sandwich, that did not duplicate a grilled sandwich.

### THE PRESENT INVENTION

The present invention relates to a frozen cheese sandwich utilizing the technology of the commercially successful peanut butter and jelly sandwich without the deficiencies caused by the mere conversion of the peanut butter and jelly sandwich to a cheese sandwich by using a slice of cheese as a substitute for the peanut butter and jelly filling. The sandwich of the present invention employs new technology directed specifically toward production of a frozen crustless sandwich having a cheese filling which can be reconstituted merely by a short microwave cycle into a grilled cheese sandwich duplicating a homemade grilled cheese sandwich. By using the present invention, there is no need for toasting to adversely affect the resulting sandwich and internal cheese.

In accordance with the present invention, there is provided a method of making a crustless sandwich comprising slices of crusted bread having a moisture content in the general range of 40%-50%. A first slice of the bread is placed on a platen having a center depression or clearance recess. The platen is moved until the bread is at a deposition station. At the deposition station, an unmelted cheese is progressively forced as a layer onto the center area of the first slice of bread leaving an outer section of the bread slice free of cheese. By forcing the cheese progressively on the first slice of bread, without use of a melting operation or a liquid cheese spread, there is no heat distortion of the bread or absorption of the cheese into the bread. The cheese is de-aerated and is deposited progressively as a solid layer of cheese at a low temperature by merely forcing the unmelted cheese onto the bread. Thus, the bread is not disturbed, but the deposited layer of cheese is not merely a slice of processed cheese. Stripes of progressively deposited unmelted cheese are forced on the first bread slice, or a rotary dispenser forces progressively a circle of unmelted cheese onto the bread. The unmelted cheese is a solid cheese layer and not a viscous sauce or processed cheese. Consequently, a selected quality cheese is forced progressively onto the first slice of bread. Thereafter, a second slice of bread is placed over the first slice to form a crusted sandwich with the deposited cheese in the center. Thereafter, the bread slices are cut into a given shape outside, but encompassing, the center area of the bread slices and the deposited solid cheese to form two bread portions with marginal areas surrounding the cheese layer. The bread slices are then pressed together at the marginal areas of the cut bread portions to seal the cheese between the bread portions forming a crustless sandwich with opposite facing bread surfaces. These surfaces are rapidly heated to a heat that toasts only a thin layer of the surfaces so that the crustless sandwich is pre-grilled and ready to eat. Such surface toasting process would not be appropriate with a slice of cheese in the middle. The cheese is not heated, thus it would retain its original condition as a cold slice. Thus, the rapidly toasted bread surfaces would not form a grilled cheese sandwich of the type normally made domestically with a processed slice of cheese. The cheese slice would stay in its same shape and merely have an outer toasted layer, still requiring subsequent toasting upon preparation by the ultimate user. The present invention, by using the deposited solid cheese, forms a cheese into the desired edible condition which need not be modified during the fast toasting of the outer surfaces.

Thereafter, the pre-grilled cheese sandwich, which is ready to eat, is frozen and hermetically sealed for commercial distribution. The ultimate consumer merely thaws the crustless sandwich and places it in a microwave oven for a short time at a medium power level. This raises the temperature of the sandwich and heats the internal cheese filling so the sandwich duplicates a homemade grilled cheese sandwich. By the present invention, there is no need to toast the sandwich after it is thawed with the resulting disturbance of the cheese filling. Since a slice of cheese is not used in the present invention, there is no need to melt the internal cheese to form it into the desired mouth texture. Consequently, the crustless pre-grilled cheese sandwich is merely microwave heated and eaten. It duplicates a homemade grilled cheese sandwich, instead of a toasted product.

In accordance with another aspect of the present invention, there is provided a frozen sandwich for commercial sales comprising a first portion of bread cut from a first slice of crusted bread. The first bread portion has an outer surface, a given periphery and a center area surrounded by a marginal area. A layer of unmelted solid cheese is deposited on the center area and spaced inwardly form the marginal area. A second portion of bread cut from a second slice of crusted bread overlies the first portion and the layer of cheese. The second bread portion has an outer surface, a periphery generally matching the periphery of the first portion and a marginal area generally matching and coextensive with the marginal area of the first portion. The marginal areas are smashed together sufficiently to form a seal at the generally matching peripheries of the bread portions. The surfaces of the bread portions are each scorched to transform a thin skin of the portions into toasted bread so that the frozen sandwich may be encapsulated in a hermetically sealed package for mere microwave reconstitution prior to consumption.

In accordance with another aspect of the present invention, the frozen sandwich is circular in shape and has spaced crimped indentations around the sealed area to provide spaced points of high physical cohesion between the bread portions, without overcompression around the total sandwich. These crimped indentations assist in positively locking the bread portions together and produce a pleasing appearance.

In accordance with another aspect of the present invention, the cheese layer has a thickness in the general range of ⅛-¼ inch and is generally free of entrapped air by forcing solid unmelted, de-aerated cheese onto the first bread slice. In practice, the moisture content of the bread is in the range of 40%-50% to assure a positive sealing action, without demanding a drastic pinch joint, such as shown in Sollerud U.S. Pat. No. 3,782,270, incorporated by reference herein.

The primary object of the present invention is the provision of a frozen sandwich that can be reconstituted by microwave into a grilled cheese sandwich with the taste, appearance and consistency of a homemade product.

Another object of the present invention is the provision of a frozen sandwich, as defined above, which frozen sandwich is hermetically packaged for commercial marketing.

Yet a further object of the present invention is the provision of a frozen sandwich, as defined above, which sandwich utilizes a center cheese filling deposited onto the sandwich progressively as an unmelted solid cheese which is preferably de-aerated.

Still a further object of the invention is the provision of a frozen cheese sandwich, as defined above, which sandwich duplicates a domestic grilled cheese sandwich and does not use a toasting operation by the consumer.

A further object of the present invention is the provision of a method of making a frozen sandwich, as defined above, which method incorporated the concept of grilling the surfaces of the sandwich preparatory to freezing in a manner that does not disturb the filling for subsequent microwave heating by the consumer.

These and other objects and advantages will become apparent by the following description taken together with the accompanying drawings.

### BRIEF DESCRIPTION OF DRAWINGS

FIG. 1 is a pictorial view of a frozen sandwich constructed with the present invention with a segment removed to show the interior of the sandwich in cross-section;

FIG. 2 is a top plan view of a first slice of bread on a platen and showing the deposition of unmelted cheese in accordance with an aspect of the present invention;

FIG. 3 is a cross-sectional view in reduced proportions taken generally along line 3-3 of FIG. 2;

FIG. 4 is a cross-sectional view of the crusted sandwich and the cutter for cutting the bread slices in a preselected shape;

FIG. 5 is a view similar to FIG. 4 showing the subsequent sealing of the cut portions to form a crustless sandwich;

FIG. 6 is a schematic view of a first conveyor for the platens used to assemble the sandwich and cut and seal the sandwich preparatory to deposition of the crustless sandwich onto an illustrated second conveyor for subsequent processing; and,

FIG. 7 is a schematic side view drawing showing progressive stations of the final process of the crustless sandwich.

### PREFERRED EMBODIMENT

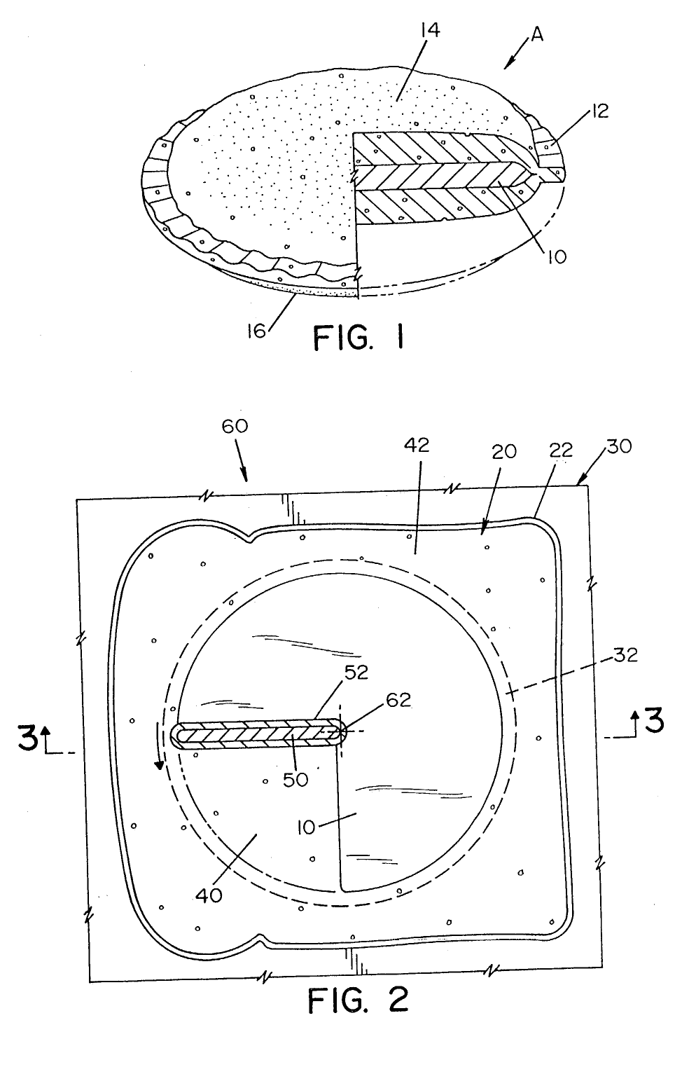

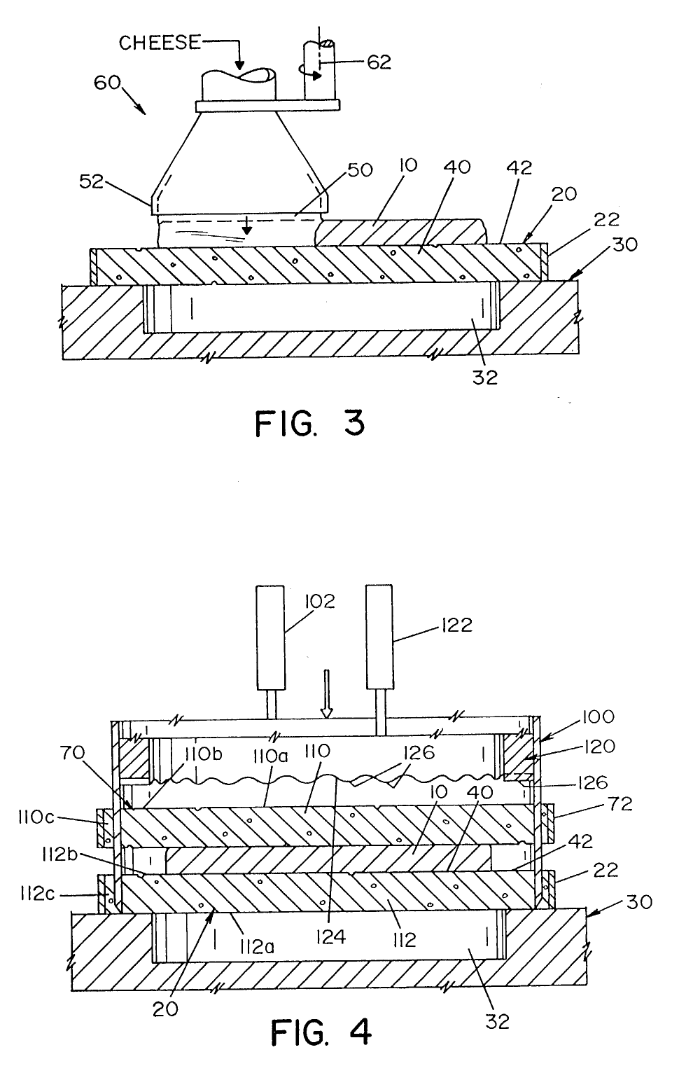

Referring now to the drawings, wherein the showings are for the purpose of illustrating preferred embodiment of the invention only and not for the purpose of limiting same, FIG. 1 shows a round frozen sandwich A with a layer of unmelted, deposited cheese 10, a sealed and then crimped periphery 12 and grilled outwardly facing surfaces 14, 16. This sandwich is initially assembled as shown in FIGS. 2-5 by providing a first slice of bread 20, preferably white bread, having a moisture content in the general range of 40%-50% and an outer crust 22. The slice of bread is placed on movable platen 30 having a center depression or recess 32 to define the center area 40 of slice 20, which center area is surrounded by the marginal area 42 and crust 22 of slice 20. At a cheese deposition station, unmelted solid cheese 50 previously de-aerated is forced from nozzle 52 by a high pressure pump. In practice, it is a Marlen pump with a reciprocating piston that has a capability of pulling a vacuum to remove all entrapped air in the cheese being forced from nozzle 52. By using a de-aerated solid cheese forcibly deposited on slice 20, an accurate pattern and weight of cheese is accomplished during deposition of cheese. The pump loads nozzle 52 with de-aerated cheese that is dispensed onto the center area 40 of the crusted bread. In practice, the deposition is either circular as illustrated in FIGS. 1 and 2 or a series of strips which pattern is accomplished by a nozzle with several openings translating across area 40 instead of a single long opening rotating over area 40. In either instance, cheese 50 is forcibly deposited on area 40 inward of marginal area 52, as shown in FIGS. 2 and 3. Layer 10 has a thickness in the general range of ⅛-¼ inch in the preferred embodiment.

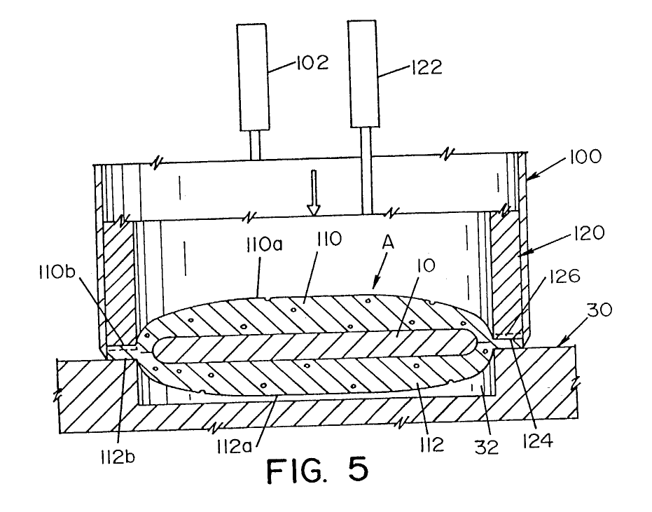

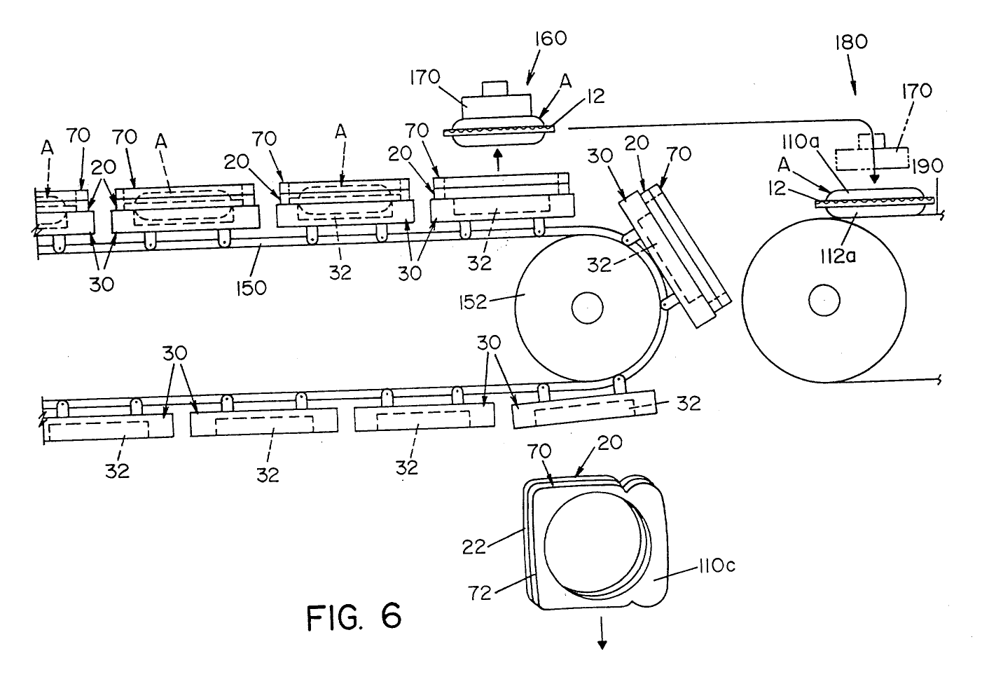

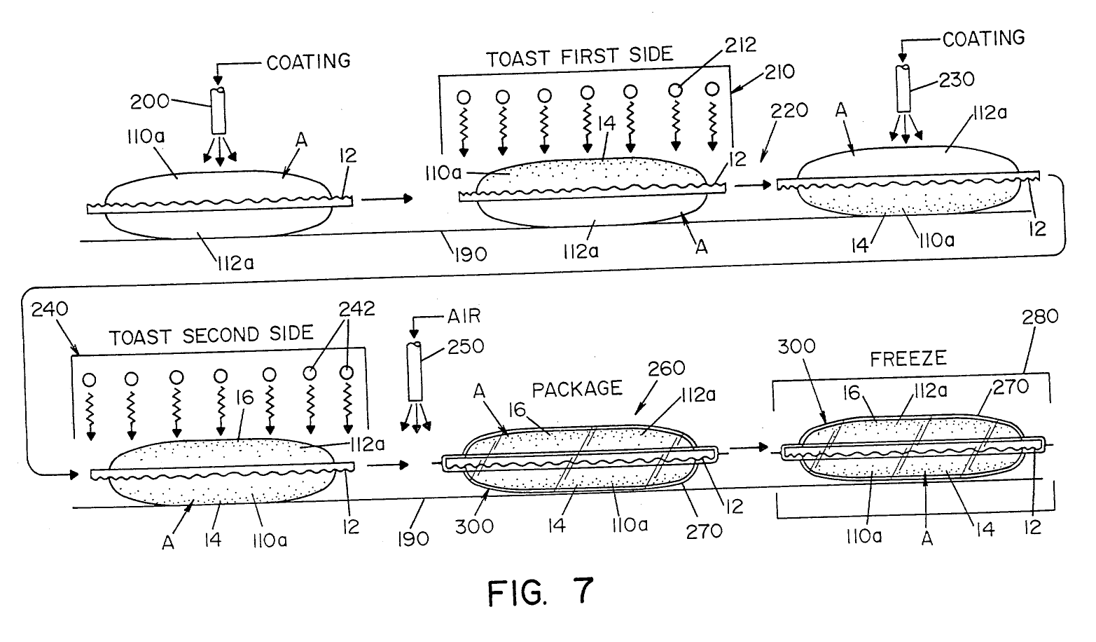

After a second bread slice 70 with crust 72 is placed over cheese layer 10, as shown in FIG. 4, a cutter, in the preferred embodiment circular cutter 100, is forced downwardly by pneumatic cylinder 102 to cut the bread slices in unison to give bread portions 110, 112 with outer surfaces 110a, 112a, marginal areas 110b, 112b and outer peripheries 110c, 112c, respectively. Crust 22, 72 is subsequently removed before or after the sealing action as shown in FIG. 5. This sealing action is accomplished by sealing ring 120 forced downwardly by pneumatic piston 122 having a lower sealing surface 124 with spaced raised projections 126 around the periphery of the sealing surface. Downward movement of ring 120 seals bread portions 110, 112 at marginal areas 110b, 112b. This is a smashing action sufficient to seal the high moisture content bread into a crustless sandwich having the forcibly deposited cheese layer 10 captured within the sandwich, but not in the sealing area of the bread portions 110, 112. The crustless sandwich A is allowed to be moved into recess 32 to have a shape generally shown in FIG. 5. Cheese layer 10 essentially duplicates a cheese layer in a grilled cheese sandwich. It is not merely a slice of cheese, which must be melted to provide the necessary consistency and mouth feel. By forcing the de-aerated solid cheese forcibly through a nozzle onto the bread slice, the consistency of the resulting cheese layer is like a grilled cheese sandwich and not a cold slice of cheese in the middle of two bread slices. Crustless sandwich A is formed for subsequent processing in accordance with the present invention. Such processing in practice involves a first conveyor 150 movable around guide roll 152, as shown in FIG. 6. Platens 30 carry crustless sandwiches A toward a pick and place station 160. Pick and place mechanism 170 removes the sandwich A, not shown in FIG. 6, to transfer the sandwich from station 160 to a station 180 above an adjacent second conveyor 190, best shown in FIG. 7. As platens 30 move around ring 152 the extra crust of slices 20, 70 are discarded into a bin for subsequent disposition. In the preferred embodiment, the outer portion of the bread remains with sandwich A until after the pick and place occurs at station 160.

After constructing sandwich A to provide a combination involving novel cheese layer 10, the crustless sandwich is processed in accordance with the invention as shown in FIG. 7. As a first operation, spray device 200 sprays a margarine or butter flavored oil onto surface 110a. This operation can be done later. The sandwich is then moved through a radiant oven 210 having radiant heaters 212 to toast a thin layer of surface 110a. Preferably an infrared oven is used; however, a belt griller, an impingement oven or continuous belt cooking system could be used. The cooking system could toast both surfaces at the same time; however, for illustrative purposes the outer surfaces 110a, 112a are toasted in succession. After toasting surface 110a, sandwich A is flipped by a device at station 220, which device merely turns the sandwich over to expose upper surface 112a. The surface is coated by spray device 230 similar to device 200 preparatory to moving sandwich A through radiant oven 240 having radiant heating units 242. This toast surface 112a completing a pre-grilled cheese sandwich having the characteristics of a homemade grilled cheese sandwich but employing the crustless bread technology of Kretchman U.S. Pat. No. 6,004,596. It does not involve a slice of processed cheese. The finished sandwich is preferably air cooled by spray device 250. At this location, the margarine or butter flavored oil of devices 200, 230 can be deposited on both surfaces 110a, 112a instead of being deposited preparatory to toasting in ovens 210, 240. The finished sandwich A is placed upon an overwrap machine 260 to apply a plastic sheet or metalized plastic sheet to provide a hermetically sealed package 270. The package sandwich 300 is moved through rapid food process freezer 280. This frozen sandwich 300 is sold commercially. A consumer merely thaws the sandwich and heats it in a microwave oven set at about 50% power for a time, i.e. preferred to be 90 seconds. The heated sandwich essentially duplicates a homemade grilled cheese sandwich.

Having thus defined the invention, the following is claimed:

1. A frozen sandwich for commercial sales comprising a first portion of bread cut from a first slice of crusted bread, said first portion having an outer surface, a given periphery and a center area surrounded by a marginal area; a layer of unmelted solid cheese deposited on said center area and spaced inwardly from said marginal area; a second portion of bread cut from a second slice of crusted bread and overlying said first portion and said layer of cheese, said second portion having an outer surface, a periphery generally matching said periphery of said first portion and a marginal area generally matching and coextensive with said marginal area of said first portion; said marginal areas being smashed together to form a seal generally matching said peripheries of said bread portions; said surfaces of said bread portions heat scorched to transform a thin skin of said portions into toasted bread; and, said frozen sandwich being encapsulated in a hermetically sealed package.

2. A frozen sandwich as defined in claim 1 wherein said peripheries are circular.

3. A frozen sandwich as defined in claim 2 wherein said seal includes spaced crimped indentations.

4. A frozen sandwich as defined in claim 1 wherein said seal includes spaced crimped indentations.

5. A frozen sandwich as defined in claim 4 wherein said package is formed of metalized plastic sheet material.

6. A frozen sandwich as defined in claim 3 wherein said package is formed of metalized plastic sheet material.

7. A frozen sandwich as defined in claim 2 wherein said package is formed of metalized plastic sheet material.

8. A frozen sandwich as defined in claim 1 wherein said package is formed of metalized plastic sheet material.

9. A frozen sandwich as defined in claim 4 wherein said package is formed of plastic sheet material.

10. A frozen sandwich as defined in claim 3 wherein said package is formed of plastic sheet material.

11. A frozen sandwich as defined in claim 2 wherein said package is formed of plastic sheet material.

12. A frozen sandwich as defined in claim 1 wherein said package is formed of plastic sheet material.

13. A frozen sandwich as defined in claim 12 including a flavor enhancing liquid on said surfaces.

14. A frozen sandwich as defined in claim 9 including a flavor enhancing liquid on said surfaces.

15. A frozen sandwich as defined in claim 4 including a flavor enhancing liquid on said surfaces.

16. A frozen sandwich as defined in claim 3 including a flavor enhancing liquid on said surfaces.

17. A frozen sandwich as defined in claim 2 including a flavor enhancing liquid on said surfaces.

18. A frozen sandwich as defined in claim 1 including a flavor enhancing liquid on said surfaces.

19. A frozen sandwich as defined in claim 18 wherein said cheese layer has a thickness in the general range of ⅛-¼ inch.

20. A frozen sandwich as defined in claim 12 wherein said cheese layer has a thickness in the general range of ⅛-¼ inch.

21. A frozen sandwich as defined in claim 8 wherein said cheese layer has a thickness in the general range of ⅛-¼ inch.

22. A frozen sandwich as defined in claim 4 wherein said cheese layer has a thickness in the general range of ⅛-¼ inch.

23. A frozen sandwich as defined in claim 3 wherein said cheese layer has a thickness in the general range of ⅛-¼ inch.

24. A frozen sandwich as defined in claim 2 wherein said cheese layer has a thickness in the general range of ⅛-¼ inch.

25. A frozen sandwich as defined in claim 1 wherein said cheese layer has a thickness in the general range of ⅛-¼ inch.

26. A frozen sandwich as defined in claim 25 wherein said cheese is generally free of entrapped air.

27. A frozen sandwich as defined in claim 18 wherein said cheese is generally free of entrapped air.

28. A frozen sandwich as defined in claim 12 wherein said cheese is generally free of entrapped air.

29. A frozen sandwich as defined in claim 7 wherein said cheese is generally free of entrapped air.

30. A frozen sandwich as defined in claim 4 wherein said cheese is generally free of entrapped air.

31. A frozen sandwich as defined in claim 3 wherein said cheese is generally free of entrapped air.

32. A frozen sandwich as defined in claim 2 wherein said cheese is generally free of entrapped air.

33. A frozen sandwich as defined in claim 1 wherein said cheese is generally free of entrapped air.

34. A frozen sandwich as defined in claim 33 wherein said bread has a moisture content in the general range of 40%-50%.

35. A frozen sandwich as defined in claim 36 wherein said bread has a moisture content in the general range of 40%-50%.

36. A frozen sandwich as defined in claim 25 wherein said bread has a moisture content in the general range of 40%-50%.

37. A frozen sandwich as defined in claim 24 wherein said bread has a moisture content in the general range of 40%-50%.

38. A frozen sandwich as defined in claim 12 wherein said bread has a moisture content in the general range of 40%-50%.

39. A frozen sandwich as defined in claim 11 wherein said bread has a moisture content in the general range of 40%-50%.

40. A frozen sandwich as defined in claim 4 wherein said bread has a moisture content in the general range of 40%-50%.

41. A frozen sandwich as defined in claim 3 wherein said bread has a moisture content in the general range of 40%-50%.

42. A frozen sandwich as defined in claim 2 wherein said bread has a moisture content in the general range of 40%-50%.

43. A frozen sandwich as defined in claim 1 wherein said bread has a moisture content in the general range of 40%-50%.

44. A frozen sandwich for commercial sales comprising a first portion of bread cut from a first slice of crusted bread, said first portion having an outer surface, a given periphery and a center area surrounded by a marginal area; a layer of solid cheese progressively deposited on said center area and spaced inwardly from said marginal area; a second portion of bread cut from a second slice of crusted bread and overlying said first portion and said layer of cheese, said second portion having an outer surface, a periphery generally matching said periphery of said first portion and a marginal area generally matching and coextensive with said marginal area of said first portion; said marginal areas being smashed together to form a seal generally matching said peripheries of said bread portions; said surfaces of said bread portions heat scorched to transform a thin skin of said portions into toasted bread.

45. A frozen sandwich as defined in claim 44 wherein said peripheries are circular.

46. A frozen sandwich as defined in claim 44 wherein said seal includes spaced crimped indentations.

47. A frozen sandwich as defined in claim 44 wherein said cheese layer has a thickness in the general range of ⅛-¼ inch.

48. A frozen sandwich as defined in claim 44 wherein said cheese is generally free of entrapped air.

49. A frozen sandwich as defined in claim 44 wherein said sandwich is encapsulated in a hermetically sealed package.

50. A frozen sandwich as defined in claim 44 wherein said bread is white.

51. A frozen sandwich as defined in claim 50 wherein said bread has a moisture content in the general range of 40%-50%.

52. A frozen sandwich as defined in claim 44 wherein said bread has a moisture content in the general range of 40%-50%.

53. A method of making a crustless sandwich, said method comprising:
(a) providing slices of crusted bread;
(b) placing a first slice of bread on a platen with a center clearance recess;
(c) moving said platen and first slice of bread to a deposition station;
(d) forcing unmelted cheese progressively as a layer onto a center area of said first slice of bread leaving an outre section of said first bread slice free of cheese;
(e) placing a second slice of bread over said first slice of bread to form a crusted sandwich;
(f) cutting said bread slices into a given shape outside, but encompassing said center area and said deposited cheese to form two bread portions with marginal areas surrounding said cheese;
(g) then, pressing said marginal areas of said cut bread portions together to seal said cheese between said bread portions forming a crustless sandwich with oppositely facing bread surfaces;
(h) heating said surfaces at a heat to toast a thin layer of said surfaces; and,
(i) then freezing said crustless sandwich.

54. The method as defined in claim 53 including spraying butter flavor oil onto said toasted surfaces.

55. The method as defined in claim 53 including conveying said crustless sandwich during said heating.

56. The method as defined in claim 53 wherein said heating is by radiation.

57. The method as defined in claim 56 wherein said conduction heating is by a belt griller.

58. The method as defined in claim 53 wherein said heating is by conduction.

59. A method as defined in claim 57 including the act of hermetically sealing said crustless sandwich before said freezing.

60. A method as defined in claim 58 including the act of hermetically sealing said crustless sandwich before said freezing.

61. A method as defined in claim 56 including the act of hermetically sealing said crustless sandwich before said freezing.

62. A method as defined in claim 55 including the act of hermetically sealing said crustless sandwich before said freezing.

63. A method as defined in claim 54 including the act of hermetically sealing said crustless sandwich before said freezing.

64. A method as defined in claim 53 including the act of hermetically sealing said crustless sandwich before said freezing.

65. The method as defined in claim 64 wherein said cheese is de-aerated.

66. The method as defined in claim 57 wherein said cheese is de-aerated.

67. The method as defined in claim 56 wherein said cheese is de-aerated.

68. The method as defined in claim 54 wherein said cheese is de-aerated.

69. The method as defined in claim 53 wherein said cheese is de-aerated.

70. The method as defined in claim 69 wherein bread of said slices has a moisture content in the general range of 40%-50%.

71. The method as defined in claim 64 wherein bread of said slices has a moisture content in the general range of 40%-50%.

72. The method as defined in claim 57 wherein bread of said slices has a moisture content in the general range of 40%-50%.

73. The method as defined in claim 56 wherein bread of said slices has a moisture content in the general range of 40%-50%.

74. The method as defined in claim 53 wherein bread of said slices has a moisture content in the general range of 40%-50%.
